(19) United States
(12) Patent Application Publication
(10) Pub. No.: US 2026/0234490 A1
(43) Pub. Date: Aug. 13, 2026

(54) PRODUCING POLYUREA-THICKENED LUBRICATING GREASES HAVING IMPROVED LUBRICATION PROPERTIES AND AGING STABILITY

(71) Applicant: FUCHS SE, Mannheim (DE)

(72) Inventors: Elmar Kessler, Kaiserslautern (DE); Thomas Litters, Hettenleidelheim (DE); Olaf Binkle, Kirkel (DE); Mathias Ronellenfitsch, Wiesloch (DE)

(73) Assignee: FUCHS SE, Mannheim (DE)

(21) Appl. No.: 19/469,844

(22) PCT Filed: Mar. 27, 2024
(86) PCT No.: PCT/EP2024/058273

§ 371 Date: Sep. 26, 2025

(30) Foreign Application Priority Data
Mar. 30, 2023 (DE) 10 2023 108 177.2

(51) Int. Cl. C10M 119/24; B01F 23/50; B01F 27/05; B01F 35/90; B01F 101/39; C10M 109/00; C10M 113/00; C10M 117/02; C10M 121/00; C10M 177/00; C10N 20/02; C10N 30/00; C10N 50/10

(52) U.S. Cl. CPC C10M 119/24; B01F 23/56; B01F 27/05; C10M 109/00; C10M 113/00; C10M 117/02; C10M 121/00; C10M 177/00; B01F 2035/98; B01F 2035/99; B01F 2101/39; C10M 2201/1013; C10M 2207/1206; C10M 2217/042; C10N 2020/02; C10N 2030/40; C10N 2050/10

(57) ABSTRACT

The invention relates to a method for the production of a polyurea-thickened grease intermediate product, consisting of or comprising the following steps: a) Providing at least one first thickener precursor; b) Providing at least one second thickener precursor; c) Dosing the thickener precursors provided from step a) and b) into a mixing chamber, optionally additional addition of at least one additive; d) mixing the at least two thickener precursors and the optionally at least one further additive in the mixing chamber and reacting the two thickener precursors; e) obtaining at least one polyurea-thickened grease intermediate product, wherein in order to ensure cooling during the reaction in step d) at least one of the thickener precursors provided in step a) and b) and/or the at least one additive from step c) has a temperature in a range from 0° C. to less than 40° C., preferably in a range from 10° C. to less than 40° C.

The present invention is situated in the field of grease production, in particular the production of polyurea-thickened greases. The invention proposes a method for the production of grease precursors and for the manufacture of the final grease. The use of an apparatus for the production of a grease according to the invention as well as a grease according to the invention are also presented.

For tribological systems such as are used in many technical applications, it is important to use lubricants to reduce friction and wear at the contact surfaces between moving parts. In such cases, lubricants of different consistencies may be used depending on the area of application. Lubricating oils have a fluid, flowable consistency, whereas greases have a semi-solid to solid—often gel-like-consistency.

The characterizing feature of a grease is that a fluid oil component is absorbed and held by a thickener component. The gel-like consistency of a grease and its properties of spreadability and easy plastic deformation combined with its adhesive ability ensure that the grease coats the lubrication point and its lubricating effect is delivered at the tribologically stressed surfaces. Besides additives, greases substantially include a thickening agent dispersed in a base oil.

Among the most important rheological properties of a grease are its consistency or Yield point, resistance to post-curing and excessive oil separation under thermal and mechanical load, and a stable viscosity-temperature behaviour and viscosity-shear behaviour. In order to create a grease of high practical value reflecting the demands of the application, a great deal of practical experience is required.

In the field of greases, it is important that the thickener is distributed in small, uniform particle size, and at the same time the thickener molecules are produced with a high degree of selectivity and substantially reduced chemical secondary reactions, in order to produce greases that are stable with regard to ageing, and material-compatible. Greases produced in this way result in longer bearing lifetime, improved bearing stability, with very good noise behaviour, improved compatibility with sealing materials, a lower health burden for users, and better environmental tolerability.

The production of polyurea-thickened greases is a key research topic. Accordingly, GB 776548A discloses a process for producing metallic soap thickened greases, which process can be applied using the principle of the method for polyurea greases as well, and in which the reaction mixture undergoes powerful shearing in a reaction zone. Alternatively, a reaction mixture that has fully or partly reacted to completion can be circulated between a shear zone and a zone without shear with the addition of fresh reactants.

EP 1062307B1 discloses a discontinuous production method that describes both soap-thickened greases and polyurea greases. For this purpose, when a polyurea grease is produced it is passed through a homogenising apparatus and undergoes shearing. This is intended to achieve good noise behaviour according to testing with the SKF BeQuiet Method.

EP 1322732B1 discloses the discontinuous production of a low-noise grease with a defined thickener particle size of 95% smaller than 100 μm. For this, the thickener is first produced by reacting diisocyanates and amines. Then, a mixture of a thickener and a base oil is sheared for a period of time at a temperature from 35° C. to 55° C. until the desired particle size is reached, then heated at a temperature from 150° C. to 175° C., and afterwards cooled to a temperature from 25° C. to 105° C. After this, the grease is ground to obtain a homogeneous lubricating grease.

US 2010/0029526A1 discloses the production of low-noise polyurea greases by the sequential addition of two or more amines pre-dissolved in oil to an isocyanate pre-dissolved in oil in a reactor.

EP1322732B1 discloses the continuous production of polyurea greases by “Reactive Injection Moulding”. In this process, the reaction partners amine and isocyanate are diluted/dissolved separately in a solvent and then injected simultaneously under high pressure into a high-pressure injection unit, thereby creating the polyurea thickener.

U.S. Pat. No. 8,703,671B2 discloses the continuous production of polyurea greases by reactive (twin) screw extruder. A feature of this process is that reaction components, such as isocyanates and amines, are introduced into the extruder at various points, while base oil ca be added in measured doses at other points of the extruder. The supply of reaction components pre-dissolved in oil is also described. The temperatures in the individual reaction zones are also described (“mixing cooling zone”).

EP3031888B1 describes the production of polyurea greases by introducing amines pre-dissolved in oil and isocyanates dissolved in oil simultaneously into a shear cell with a defined shear rate of more than 10² l/s. In this context, the shear rate is defined as the quotient of the relative velocity between a rotating inner component and the inner wall of the shear cell and the smallest distance between these two components. The shearing of the reaction components pre-dissolved in oil takes place within 15 min after they are combined. The reaction between isocyanate and amine takes place at 60-120° C.

EP3255130A1 describes the production of a low-noise grease on the basis of at least one aromatic amine and further amines according to a process EP3031888 in which it is applied in such a way that the average thickener particle size of the correspondingly produced grease has an arithmetic mean of <1.6 μm. The mean particle size is determined using the static light scattering method.

EP 3150688 B1 describes the production of a grease on the basis of isocyanate and a mixture of alicyclic and aliphatic amines according to the method of EP3031888. The noise requirements of the correspondingly produced grease are “Peak High 32-64s of ≤1.5 and a Level High 32-64s of ≤10” and is defined using the FAG method (also known as ISO 21250-3 “method MQ”).

JP 2017115109A describes a special design of the rotor/stator shear cell presented in EP 3031888, in which the shear rate of amines pre-dissolved in oil and isocyanates pre-dissolved in oil can be adjusted independently of the speed of the rotating component by varying the shearing gap width.

The prior art does not indicate that the reaction temperature is significant for the quality of the grease obtained. The methods for producing polyurea greases known hitherto describe either continuous production processes, which cannot be used in the agitation reactors popular in the lubricant industry for batch production of greases, or discontinuous methods, in which a solution for the problem of the shear heating that occurs at high shear rates and the exothermic reaction of amines, alcohols and isocyanates has not been found. This results in the formation of undesirable chemical byproducts or decomposition products during synthesis of the thickener, and consequently in unfavourable grease properties.

Accordingly, free amines reformed during a heat-induced dissociation of the urea group can lead to increased plastic intolerability and skin intolerance. Free amines can also pose an increased odour nuisance. Free amines also represent a toxicological health risk for users. Moreover, a higher reaction temperature might also cause volatile amines or alcohols (such as cyclohexylamine/cyclohexanol) which have not yet fully reacted with isocyanate to evaporate and as a consequence they do not yield the desired polyurea thickener and its properties (e.g., degree of thickening). Another effect that might occur is that isocyanates which have not yet fully reacted with amines and alcohols also decompose, due to excessively high temperature and possible residual moisture present in the oils, via intermediate formation of carbamic acid and subsequent decarboxylation to make free aromatic amines, which are associated with a range of disadvantages as noted previously. Moreover, free isocyanates pose a toxicological health risk to users. Furthermore, a possible oligomerisation of isocyanates (uretdione formation, isocyanurate formation) or the formation of biuret oligomers or allophanate oligomers might impair the thickening performance and lead to increased thermal and oxidative ageing of greases. It has been noted empirically that free amines, alcohols or isocyanates often result in unintended re-solidification of polyurea-greases during storage or use.

The object of the present invention was therefore to provide a method for the production of a polyurea-thickened grease of high quality an good ageing stability, and to limit the formation of undesirable byproducts in the production step for the thickener.

This object was solved according to the invention in a first aspect with the provision of a method for producing at least one polyurea-thickened grease intermediate product, which consists of or includes the following steps:
a) Providing at least a first thickener precursor;
b) Providing at least a second thickener precursor;
c) Dosing the thickener precursors provided from steps a) and b) into a mixing chamber, optionally also addition of at least one further additive;
d) Mixing the at least two thickener precursors and the optionally at least one further additive in the mixing chamber and reacting the two thickener precursors;
e) Obtaining at least one polyurea-thickened grease intermediate product;
   wherein in order to ensure cooling during the reaction in step d) at least one of the thickener precursors provided in steps a) and b) and/or the at least one additive from step c) has a temperature in a range from 0° C. to less than 40° C., preferably in a range from 10° C. to less than 40° C.

The present invention deals generally with the production of greases on the basis of various base oils and thickeners on organically substituted ureaand/or urethane molecules with aliphatic, cycloaliphatic and aromatic hydrocarbon groups. Due to the simultaneous presence of multiple urea or urethane groups, corresponding lubricating greases are called polyurea or polyurethane greases, or in a hybrid form also polyurea/polyurethane greases. In general, polyurea grease or polyurea-thickened grease is the term used to describe the group.

A “grease intermediate product” within the scope of the present invention is a product that functions as the basis for a lubricating grease but is still processed further so that it can be used in grease-lubricated tribological systems. The grease intermediate product is usually a thickener, which may already be present with at least one base oil and/or at least one additive and is converted into a finished product by means of further process steps, such as heating or grinding. Moreover, the grease intermediate product or thickener may preferably be a polyurea thickener, which is subsequently transformed into a finished polyurea-thickened grease product in further process steps with the addition of further base oils and further additives.

The thickener precursors provided in steps a) and b) are educts which react in the mixing and reaction step d) to form the thickener or grease intermediate product. They are preferably amines and/or alcohols and isocyanates as described in the following text.

The additive added in step c) is an optional component in grease production and may be added in order to improve or obtain certain properties of the grease.

In one embodiment, the grease intermediate product is a polyurea thickener consisting of the reaction products from amines and isocyanates. According to one embodiment, the polyurea thickener may be obtained as a product of the reaction of diisocyanates with C6- to C20-hydrocarbyl monoamines. Or the products of reaction of mono-isocyanates, optionally plus diisocyanates as well, with diamines also be present. The polyurea thickeners are more preferably not polymeric in nature, but are for example dimers, trimers, tetramers or other oligomers. Thus, R-NCO type (monoisocyanate) isocyanates may also be used as well as the polyisocyanates, where R represents a hydrocarbon radical with preferably 5 to 20 carbon atoms.

Diureas can preferably be obtained from diisocyanates and monoamines, or tetraureas can be obtained from diisocyanates, monoamine and diamine, each defined as above. Particularly preferable are diureas based on 4,4′-diphenylmethane diisocyanate (MDI) or toluenel-2,4-diisocyanate (TDI) and aliphatic, aromatic and/or cyclic primary monoamines, or tetraureas based on MDI or TDI and aliphatic, aromatic and/or cyclic monoand diamines.

Step d), in which the two thickener precursors provided in steps a) and b) are mixed with each other, is the step responsible for production of the grease intermediate product, preferably the polyurea thickener. For this purpose, a preferably provided amine and/or a provided alcohol react(s) exothermically with an isocyanate to yield urea or urethane.

The concentrations of desired urea molecules/urethane molecules and undesirable byproducts that occur in the reaction of the polyurea thickeners is determined primarily by the speeds of their reactions and equilibrium positions. The equilibrium position is displaced considerably to the products by the exothermic nature of the reactions. The reaction speed depends on the reaction kinetics and the mass transfer. The reaction kinetics increases as the temperature rises. The mass transfer is dependent to a substantial degree on the concentration of the educts and the flow behaviour (e.g., mixture/viscosity) and is therefore also linked indirectly to the temperature. Reactions at high kinetics are typically limited by the mass transfer, whereas the mass transfer in kinetically limited reactions is often less important. The kinetics of urea formation/urethane formation by reacting amines/alcohols with isocyanates is very high. Consequently, it is rather limited by the mass transfer, which is why in the prior art shearing often takes place during the reaction. Compared with the urea formation reaction, the kinetics of the undesirable secondary reactions is slow, and therefore mostly kinetically limited. If the temperature of the reaction is raised, the kinetics of the secondary reactions increases, whereas the urea formation/urethane formation reaction is not significantly altered by mass transfer limitation. This means that a rise in the reaction temperature results in increased formation of byproducts.

Surprisingly, it was discovered according to the invention that the formation of byproducts can be limited by adding at least one of the thickener precursors and/or at least one additive at a temperature between 0° C. to less than 40° C., preferably in a range from 10° C. to less than 40° C., particularly preferably in a range from 10° C. to less than 35° C. This is particularly surprising, given that in the prior art the reactor jacket is cooled to control the temperature, in particular in an agitation reactor. However, this cooling via the reactor jacket is not sufficient to enable the temperature in the reactor to be adjusted to such a degree as to minimise the formation of byproducts. Insufficient cooling via the reactor jacket can be observed in particular when the thickening effect of the grease intermediate product produced starts, and the convective heat transfer is substantially reduced. In contrast to the abovementioned prior art, which in this respect largely contains no information about the influence of temperature or cooling, according to the invention a particularly advantageous method is defined by the temperature range presented.

in step c) a cooled additive is preferably added at a temperature from 0 to 40° C., preferably at a temperature from 10° C. to less than 40° C., particularly preferably at a temperature from 10° C. to less than 35° C. It is particularly preferable if the additive is a cooled base oil.

The at least one additive can preferably be added at a temperature below 0° C. in step d) to bring about cooling. When added at temperature preferably below 0° C., the formation of condensation moisture is avoided by means known to the person skilled in the art, for example through the use of a dry atmosphere or inert gas.

The present invention is preferably associated with a method according to the invention, wherein the first thickener precursor provided in step a) is selected from the group consisting of primary amines, preferably monoamino hydrocarbyl-, di- or polyamino hydrocarbylene compounds having 6 to 20 carbon atoms or alcohols with hydrocarbylor hydrocarbylene groups having 6 to 20 carbon atoms, or mixtures thereof, wherein the first thickener precursor is present as the pure substance or in mixture with at least one base oil.

Amines that are suitable as the first thickener precursor are identified for example in EP 0508115 A1 from page 1, line 51 to the bottom of page 16. The suitable alcohols may also contain hydrocarbyl- or hydrocarbylene groups, each preferably having 6 to 20 carbon atoms, particularly preferably 6 to 18 carbon atoms. The hydrocarbylene group preferably includes aliphatic groups, which are in particular alkyl or alkylene groups. Aromatic groups may also serve. They may be monoalcohols, diols or polyols. Monoalcohols and D-alcohols are preferred, particularly preferably monoalcohols with a chain length from 6 to 18 carbon atoms.

The base oil may be classified as mineral oil or synthetic oil. Naphthenic mineral oils and paraffinic mineral oils, for example, are considered mineral oils based on their classification in API Group I. Chemically modified mineral oils with low aromatic and sulphur content and a low proportion of saturated compounds and improved viscosity/temperature behaviour compared with API Group I oils, classified in API Groups II and III, are also suitable.

Synthetic oils are understood to include in particular polyethers, esters, polyalphaolefins, polyglycols and alkylated aromatics and mixtures thereof as well as silicone oils. The polyether compound may contain free hydroxyl groups, but it may also be completely etherified or end-group esterified and/or produced from a starter compound with one or more hydroxyand/or carboxyl groups (—COOH). Polyphenyl ethers, optionally alkylated, as sole components, or better still as hybrid components, are also possible. Esters of an aromatic di-, tri- or tetracarboxylic acid with a C2- to C22-alcohol or a mixture of several such alcohols, esters of adipic acid, sebacic acid, trimethylolpropane, neopentyl glycol, pentaerythritol or dipentaerythritol with aliphatic branched or unbranched, saturated or unsaturated C2 to C22-carboxylic acids, C18-dimer acid esters with C2- to C22-alcohols, complex esters, as single component or in mixture, are suitable for use.

The method according to the invention also preferably relates to a method wherein the at least second thickener precursor provided in step b) is selected from the group consisting of: isocyanates, preferably mono- and/or polyisocyanates with 5 to 20, particularly preferably 6 to 15 carbon atoms, or mixtures of the abovementioned, wherein the second thickener precursor is present as the pure substance or as a mixture with at least one base oil.

Mono- and/or polyisocyanates wherein the polyisocyanate are preferably hydrocarbons with two isocyanate groups are suitable for use as the isocyanate component (second thickener precursor). The isocyanates include 5 bis 20, preferably 6 to 15 carbons and preferably contain aromatic groups.

Preferred within the scope of the present invention is a method according to the invention wherein the at least one additive is selected from the group consisting of base oils, volatile hydrocarbons, cooled or liquefied gases, amines, alcohols, isocyanates, antioxidants, wear protection agents, corrosion inhibitors, detergents, dyes, lubricity enhancers, bonding enhancers, viscosity additives, friction reducers, high-pressure additives or metal deactivators, simple and/or complex soaps, preferably in the form of lithium-, sodium-, magnesium-, calcium-, aluminium- or titanium soaps, water or mixtures thereof.

These soaps may be added either as additives or alternatively they may also be formed in situ during the production of the greases. The polyurea-thickened grease intermediate product or polyurea thickener and the soap- or complex soap thickener are preferably used together and processed further to yield a finished product, wherein lithium soaps, aluminium- or aluminium complex soaps, calcium sulphonate- or calcium sulphonate complex soaps, calcium soaps or calcium complex soaps are particularly preferable, preferably in a mix ratio from 10:1 to 1:10, in particular 5:1 to 1:5 (mass:mass in each case). Soap- or complex soap thickeners and polyurea thickeners are then used preferably together in quantities of 5 to 25% by weight relative to the polyurea-thickened grease (finished product), wherein the polyurea-thickened grease intermediate product or the polyurea thickener is used in a quantity of at least 1% by weight, preferably in a quantity of at least 1.5% by weight relative to the polyurea-thickened grease (finished product) in each case.

Solid greases such as polymer powders, preferably polyamides, polyimides or PTFE, melamine cyanurate, graphite, metal oxides, boron nitride, silicates, e.g., magnesium silicate hydrate (talcum), sodium tetraborate, potassium tetraborate, metal sulphides such as molybdenum disulphide, tungsten disulphide or hybrid sulphides based on tungsten, molybdenum, bismuth, tin and zinc, inorganic salts of the alkaline metals and alkaline earth metals, for example such as calcium carbonate, sodium- and calcium phosphate, may preferably be used as additives. Carbon black or other carbon-based solid lubricants such as nanotubes may also preferably be added as additives. Lignin derivatives such as alkalior alkaline earth lignin sulphonates, in particular calcium lignin sulphonates, are also usable in order to obtain specific properties, e.g., 2 to 15% by weight (according to WO2011095155A1 or U.S. Pat. No. 8,507,421 B2).

Organic carbonates that improve the performance characteristics of the polyurea-thickened greases according to the invention, and the compatibility of polyurea-thickened greases with fluorinated elastomers through the use of organic carbonates may also be introduced as additives. The organic carbonates preferably have 4 to 8 carbon atoms. The radicals or constituents of the organic carbonates are hydrocarbons (apart from the carbonate group itself), i.e. the organic carbonate is not heteroatom-substituted. Cyclic carbonates, in particular with 4 to 8, in particular 4 or 5 carbon atoms are preferred. The organic cyclic carbonate may be added to the polyurea-thickened grease according to the invention during the production, but more preferably as additive in the cooling phase after production of the polyurea-thickened grease intermediate product.

Further additives that may preferably be added within the scope of the present invention are preferably selected from:
primary antioxidants such as amine compounds (e.g., alkylamines or 1-phenylaminonaphthaline), aromatic amines such as, phenylnaphthyl amines or diphenylamine or polymeric hydroxyquinoline (e.g., TMQ), phenol compounds (e.g., 2.6-di-tert-butyl-4-methylphenol), zinc dithiocarbamate or zinc dithiophosphate;
secondary antioxidants such as phosphites, e.g., tris(2,4-ditert-butylphenyl phosphite) or bis(2,4-ditert-butylphenyl)-pentaerythritol diphosphite or thioethers (e.g., cresol thioethers);
high-pressure additives and/or wear protection additives such as sulphur or organic sulphur compounds such as polysulphides or sulphurised olefins, overbased calcium sulphonates, thiophosphates, phosphorus compounds such as amine-neutralised alkyl phosphates;
inorganic or organic boron compounds, zinc dialkyl dithiophosphate, organic bismuth compounds; thiophosphonates such as triphenyl thiophosphate, phosphonates (phosphites) such as dioctyl phosphonate, alkyl sulphonates, thiocarbamates such as methylene-bis(dibutyl dithiocarbamates and dithiocarbamates.
“oiliness” enhancing substances such as C2- to C6-polyols, fatty acids, fatty acid esters or animal or vegetable oils;
corrosion inhibitors such as sulphates, e.g., petroleum sulphonate, dinonylnaphthaline sulphonate or sorbitan esters; neutral or overbased calcium sulphonates, magnesium sulphonates, sodium sulphonates, calcium- and sodium naphthaline sulphonate, sulphonic acid esters, disodium sebacate, calcium salicylate, aminophosphates, succinates;
metal deactivators such as benzotriazoles, e.g., methylbenzotriazole dialkylamine, sterically hindered phenols, sodium nitrite;
viscosity enhancers such as polymethacrylate, polyisobutylene, oligo dec-1-enes, polystyrenes;
friction reducers partially with wear protection properties such as organomolybdenum complexes (OMC), molybdenum-dialkyl-dithiophosphates, molybdenum-dialkyl-dithiocarbamates, in particular molybdenum-di-n-butyl dithiocarbamate and molybdenum-dialkyl dithiocarbamate (Mo₂ₘSₙ(dialkyl carbamate)₂ where m=0 to 3 and n=4 to 1), zinc dithiocarbamate or zinc dithiophosphate;
or a trinuclear molybdenum compound corresponding to the formula

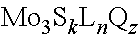

in which L are independently selected ligands having organogroups with carbon atoms, such as are disclosed in U.S. Pat. No. 6,172,013 B1, in order to render the compound soluble or dispersible in the oil, wherein n ranges from 1 to 4, k ranges from 4 to 7, Q is selected from the group of neutral electron donor compounds made up of amines, alcohols, phosphines and ethers, and z is in the range from 0 to 5 and includes non-stoichiometric values (compare DE 102007048091);
organic acids such as isostearic acid, functional polymers such as oleyl amides, organic polyether- and amide-based compounds, e.g., alkyl polyethylene glycol tetradecylene glycol ether, PIBSI (polyisobutylene succinimide) or PIBSA (polyisobutylene succinic anhydride), partial glycerides, dialkyl hydrogen phosphonates, alkyl succinates.

Further preferred is a method according to the invention wherein a cooling of the reaction in step d) is also achieved by adding evaporating components as additives in step c).

When evaporating components are used, cooling is enabled by taking advantage of the evaporation enthalpy of these components. The boiling point of these components is preferably below the reaction temperature that is attained for the two thickener precursors.

Also preferable within the scope of the present invention is a method according to the invention wherein a cooling of the reaction in step d) is also achieved by adding sublimating components as additives in step c).

The method according to the invention preferably relates to such a method wherein the base oil has a kinematic viscosity from 12 to 2500 mm²/s, preferably from 30 to 500 mm²/s at a temperature of 40° C.

It is also preferable within the scope of the present invention that the mixing in step d) takes place in the mixing chamber under shear.

Educts that are poorly soluble or insoluble in base oil may preferably be converted into a grease intermediate product in the mixing chamber under shear. Such educts that are poorly soluble or insoluble in base oil at temperatures below 20° C. may preferably also be converted under shear as described herein.

During the formation reaction of the polyurea-thickened grease intermediate product (thickener) di- or tetraurea-depending on the raw materials chosen and their stoichiometry—may be formed for example from amines (or alcohol) and isocyanate. These molecules may cluster together and form a three-dimensional thickener structure as a result of the heating process, wherein one may also talk of thickener particles in this context. The kinetics including the temperature control and mechanical shear in the mixing or shear chamber may influence the three-dimensional formation of the thickeners and therewith also the properties thereof.

Shearing is carried out preferably with a shear rate of at least 10² l/s, preferably with a maximum shear rate of 10⁷ l/s, particularly preferably in a range from at least 10² l/s to a maximum of 10⁶ l/s.

The shear rate is preferably calculated from a ratio between the velocity difference of the adjacent rotating and non-rotating components (e.g. rotor and stator) and the distance between them.

It also preferably falls within the scope of the present invention when the shear is carried out with at least one of the following:
rotor-rotor shearing mechanism, i.e. for example and preferably a homogenising apparatus with two rotatable shearing elements arranged inside a housing or vessel, which can be driven in opposite directions or the same direction, as described for example in a European patent with number EP 1125625 or EP 1825 907.
rotor-stator shearing mechanism, i.e. for example and preferably a homogenising apparatus with one rotatable shearing element arranged inside a housing or vessel, which is movable relative to a fixed position stator, as described for example in European patent EP3031888B1 or EP3255130A1,
rotor-stator-rotor shearing mechanism, i.e. for example and preferably a homogenising apparatus with two rotatable shearing elements arranged inside a housing or vessel, which can be driven in opposite directions or the same direction, and an additional fixed position stator, as described for example in said European patent with number EP 1125625 or EP 1825 907.
high-pressure injection chamber,
static mixer,
extruder, in particular screw extruder.
pump unit/pump.

The shearing is carried out particularly preferably in a rotor-rotor-stator system as described in EP 1125625 or EP 1825 907. In a preferred embodiment, the method according to the invention may be such a method for the production of a polyurea-thickened grease consisting of or including the steps as described previously, and further including the steps:
f) Heating the intermediate product obtained in step e) to a temperature above 100° C. with stirring;
g) Cooling the heated intermediate product from step f) to a temperature below 100° C., preferably below 80° C.;
h) Obtaining a polyurea-thickened grease.

The polyurea-thickened grease obtained in step h) may preferably be considered as the finished product for use in tribological systems.

A further aspect of the present invention is a method for the production of at least one polyurea-thickened grease intermediate product, consisting of or including the following steps:
a) Providing at least a first thickener precursor;
b) Providing at least a second thickener precursor;
c) Dosing the thickener precursors provided from steps a) and b) into a mixing chamber, optionally also adding at least one additive;
d) Mixing the at least two thickener precursors and the optionally at least one further additive in the mixing chamber and reacting the two thickener precursors;
e) Obtaining at least one polyurea-thickened grease intermediate product;
wherein pure amine or a mixture of pure amines and/or alcohol is provided as the first thickener precursor.

A thickener precursor of pure amine is understood to mean that the thickener precursor is entirely or substantially free from base oils and/or additives as described herein.

More preferable and as described earlier, is that at least one amine is selected as first thickener precursor provided in step a), preferably chosen from the group consisting of primary amines, preferably monoaminohydrocarbyl-, di- or polyaminohydrocarbylene compounds with 6 to 20 carbon atoms, or mixtures of those listed previously,
and/or
that at least one alcohol is selected as first thickener precursor provided in step a), preferably chosen from the group consisting of alcohols with hydrocarbyl or hydrocarbylene groups with 6 to 20 carbon atoms, or mixtures of those listed previously,
and
the second thickener precursor, provided in step (b), is chosen from the group consisting of isocyanates, preferably of mono- and/or polyisocyanates with 5 to 20, particularly preferably 6 to 15 carbon atoms, or mixtures of those listed previously,
wherein the first and/or the second thickener precursor is present as pure substance or as a mixture with at least one base oil.

The method according to the invention as described previously preferably further includes the steps:
f) Heating the intermediate product obtained in step e) to a temperature above 100° C. with stirring;
g) Cooling the heated intermediate product from step f) to a temperature below 100° C., preferably below 80° C.;
h) Obtaining a polyurea-thickened grease.

As noted earlier, a polyurea-thickened grease obtained within the scope of the present invention is the method product from the in-situ reaction of the amines and isocyanates described herein, preferably in the base oil, which is subsequently heated for the production of the intermediate product and then cooled again to obtain the polyurea-thickened grease as finished product.

In the preceding text, the invention has been described with reference to a method. In a further aspect, the invention relates to an apparatus and/or the use of an apparatus. The invention solves the object as defined in the introduction with regard to the apparatus and/or use thereof in that the apparatus comprises a mixing chamber for mixing the thickener precursors, and an agitation reactor. The mixing chamber preferably includes a shearing element and at least two dosing inlets for metered introduction of thickener precursors. The mixing chamber is preferably connected to the agitation reactor via a line. The agitation reactor is preferably equipped with a stirrer. The agitation reactor preferably also has a cooling jacket which is configured to cool the agitation reactor down. According to one embodiment, the agitation reactor is connected to the mixing chamber via a connection.

The apparatus and its use exploit the same advantages and preferred embodiments as the method according to the invention, and vice versa. In this regard, reference is herewith mad to the preceding explanations, and the content thereof is incorporated herein.

A further aspect of the present invention is the provision of a polyurea-thickened grease, preferably obtained or obtainable with a method according to one of the preceding embodiments, containing
a) 55 to 95% by weight, preferably 70 to 90% by weight base oil;
b) 1 to 20% by weight, preferably 1.5 to 15% by weight polyurea thickener; and optionally at least one further component
c) 0.5% by weight to 40% by weight, preferably 2 to 10% by weight additives;
d) 0 to 20% by weight, preferably 0 to 5% by weight, inorganic thickeners, preferably silicon oxide;
f) 0 to 20% by weight, preferably 0.1 to 15% by weight, solid lubricants;
g) 0 to 20% by weight, in particular 1 to 15% by weight, further organic thickeners, preferably soap- or complex soap thickeners based on calcium-, lithium- or aluminium soaps,
h) 1 to 15% by weight lignin derivatives,
wherein the polyurea-thickened grease is substantially free from biuret.

Biuret is formed as an undesirable byproduct, e.g., as biuret oligomers, during reaction of free isocyanates and/or isocyanates that have been partially converted with amines. This is unwelcome, because it can result in impaired thickening performance and increased thermal and oxidative ageing of greases. Moreover, biuret can dissociate over the course of the process in such manner that a free amino group arises. As described earlier, free amines that are reformed as a result of a thermally induced dissociation of the urea group can lead to increased plastic and/or elastomer intolerability and skin intolerance. Free amines can also pose an increased odour nuisance. Free amines also represent a risk of toxicological injury for users.

In the context of the present invention, the phrase “substantially free from” means values for certain substances that are below the detection threshold or present in a quantity of not more than 2000 ppm, preferably 1000 ppm, particularly preferably 500 ppm.

The polyurea-thickened grease according to the invention preferably has a cone penetration value from 200 to 400 mm/10, preferably from 265 to 385 mm/10, determined in accordance with DIN ISO 2137.

The penetration of a grease is understood to be the penetration depth-measured in 0.1 mm—of a standard cone under defined conditions.

It is preferable if a soap—or complex soap thickener is present in the polyurea-thickened grease as component g). If this is the case, the soap- or complex soap thickener is added for example after production of the base grease at a suitable temperature (e.g., at 140 to 115° C., addition of the soap- or complex soap thickener, in particular the calcium soap or calcium complex-soap) during the cooling curve.

In order to produce the base grease, the temperature is preferably raised to above 100° C. or particularly preferably above 130° C. The heating takes place after the thickener precursors have reacted to form the grease intermediate product. The conversion to the base grease is carried out in a heated reactor, which may also be designed as an autoclave or vacuum reactor.

After that, the formation of the thickener structure is completed in a second step by cooling down, and further components such as additives and/or base oil are optionally added to set the desired consistency or the desired property profile. The second step may take place in the same reactor that was used for the first step, but the base grease is preferably removed from the reactor and transferred to a separate stirred tank for cooling and mixing in any further constituents.

In the following text, the invention will be described in greater detail based on a preferred embodiment and with reference to the accompanying drawing.

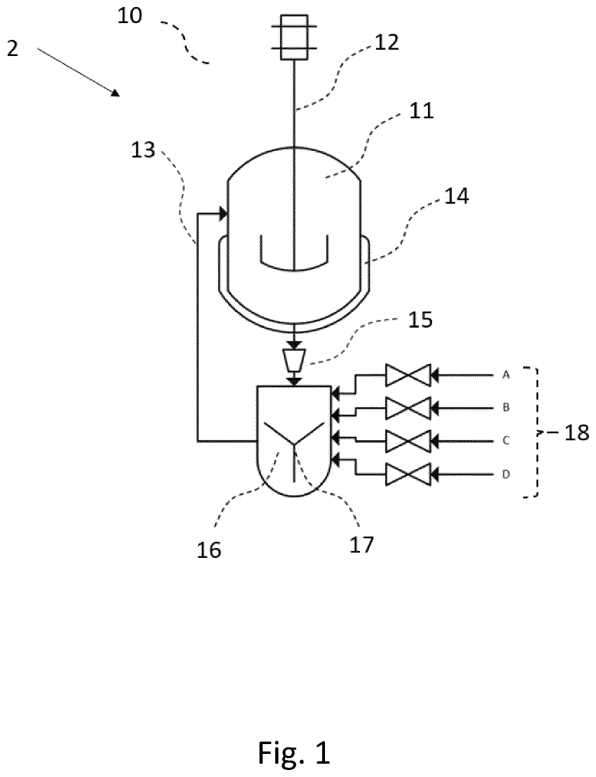

FIG. 1 shows an exemplary embodiment of a system 2 for the method according to the invention and the use according to the invention. The system 2 includes a mixing chamber 16 for mixing the thickener precursors and an agitation reactor 11. The mixing chamber 16 is equipped with a shearing element 17 and dosing inlets 18 for dosed introduction of the thickener precursors. The figure shows four separate dosing inlets A-D for exemplary purposes, although specifically for the method suggested here three inlets are sufficient. The mixing chamber 16 is connected to the agitation reactor 11 via a line 13. The agitation reactor 11 has a stirrer 12 and a cooling jacket 14. The agitation reactor 11 is connected to the mixing chamber 16 via a connection 15.

The mixing chamber 16 includes the shearing element 17, wherein the shearing element 17—as shown—may be embodied as a rotating shearing element 17 or as a rotor-rotor shearing mechanism, a rotor-stator shearing mechanism, a rotor-stator-rotor shearing mechanism, high-pressure injection chamber, static mixer, extruder, in particular a screw extruder, or as a pump unit/pump.

Referring to FIG. 1, the method according to the invention may be described as follows: The first thickener precursor and the second thickener precursor are introduced in metered quantities into the mixing chamber 16 via dosing inlets 18, for example dosing inlets A and B. The thickener precursors are mixed in the mixing chamber 16, causing the thickener precursors react, and are subjected to shear the shearing element 17. An additive may optionally be dosed into the mixing chamber 16, for example via dosing inlet C. At least one of the thickener precursors and/or the additive are added according to the invention at a temperature in a range from 0° C. to less than 40° C. The mixture may be transferred to the agitation reactor 11 as a mixture via the line 13, where it is agitated by the stirrer 12. Additionally, the fluid contained in the agitation reactor 11 may be cooled by means of the cooling jacket 14. The fluid may be transferred out of the agitation reactor 11 and into the mixing zone 16 via connection 15. In order to obtain polyurea-thickened grease from the polyurea-thickened grease intermediate product, the intermediate product is heated in the agitation reactor 11 to a temperature above 100° C. while stirring, then immediately cooled again, and finally the polyurea-thickened grease is obtained.

1. A method for the production of a polyurea-thickened grease intermediate product, consisting of or comprising the following steps:
a) Providing at least one first thickener precursor;
b) Providing at least one second thickener precursor;
c) Dosing the provided thickener precursors from step a) and b) into a mixing chamber, optionally additionally adding at least one additive;
d) Mixing the at least two thickener precursors and the optional at least one further additive in the mixing chamber and reacting the two thickener precursors;
e) Obtaining at least one polyurea-thickened grease intermediate product;
wherein in order to ensure cooling during the reaction in step d) at least one of the thickener precursors provided in steps a) and b) and/or the at least one additive from step c) has a temperature in a range from 0° C. to less than 40° C., preferably in a range from 10° C. to less than 40° C.

2. The method according to claim 1, wherein the first thickener precursor provided in step a) is selected from the group consisting of primary amines, preferably monoamino hydrocarbyl-, di- or polyamino hydrocarbylene compounds with 6 to 20 carbon atoms or alcohols with hydrocarbyl or hydrocarbylene groups with 6 to 20 carbon atoms, or mixtures of the aforementioned,
wherein the first thickener precursor is present as pure substance or as a mixture with at least one base oil.

3. The method according to claim 1, wherein the at least second thickener precursor provided in step b) is selected from the group consisting of: isocyanates, preferably mono- and/or polyisocyanates with 5 to 20, particularly preferably 6 to 15 carbon atoms, or mixtures of the aforementioned,
wherein the second thickener precursor is present as pure substance or as a mixture with at least one base oil.

4. The method according to claim 1, wherein the at least one additive is selected from the group consisting of base oils, volatile hydrocarbons, cooled or liquefied gases, amines, alcohols, isocyanates, antioxidants, wear protection agents, corrosion inhibitors, detergents, dyes, lubricity enhancers, bonding enhancers, viscosity additives, friction reducers, high-pressure additives or metal deactivators, simple and/or complex soaps, preferably in the form of lithium-, sodium-, magnesium-, calcium-, aluminium- or titanium soaps, water or mixtures thereof.

5. The method according to claim 1, wherein a cooling of the reaction in step d) is further ensured by adding evaporating or sublimating components as additives in step c).

6. The method according to claim 1, wherein the base oil has a kinematic viscosity from 12 to 2500 mm²/s, preferably from 30 to 500 mm²/s at a temperature of 40° C.

7. The method according to claim 1, wherein the mixing in step d) takes place in the mixing chamber under shear.

8. The method according to claim 7, wherein the shearing takes place with a shear rate of at least 10² l/s, preferably with a maximum shear rate of 10⁷ l/s, particularly preferably in a range from at least 10² l/s to a maximum of 10⁶ l/s.

9. The method according to claim 7, wherein the shearing is performed by means of at least one of the following:
Rotor-rotor shearing mechanism,
Rotor-stator shearing mechanism,
Rotor-stator-rotor shearing mechanism,
High-pressure injection chamber,
Static mixer,
Extruder, in particular screw extruder,
Pump unit/pump.

10. A method for production of a polyurea-thickened grease, consisting of or comprising the steps according to claim 1 and additionally the steps:
f) Heating the intermediate product obtained in step e) to a temperature above 100° C. with stirring;
g) Cooling the heated intermediate product from step f) to a temperature below 100° C., preferably below 80° C.;
h) Obtaining a polyurea-thickened grease.

11. A method for production of at least one polyurea-thickened grease intermediate product, consisting of or comprising the following steps:
a) Providing at least one first thickener precursor;
b) Providing at least one second thickener precursor;
c) Dosing the provided thickener precursors from step a) and b) into a mixing chamber, optionally additionally adding at least one additive;
d) Mixing the at least two thickener precursors and the optional at least one further additive in the mixing chamber and reacting the two thickener precursors;
e) Obtaining at least one polyurea-thickened grease intermediate product
wherein pure amine or a mixture of pure amines and/or alcohol is provided as the first thickener precursor.

12. The method according to claim 11, wherein at least one amine is selected as first thickener precursor provided in step a), preferably selected from the group consisting of primary amines, preferably monoamino hydrocarbyl-, di- or polyaminohydrocarbylene compounds with 6 to carbon atoms, or mixtures of the aforementioned,
and/or
wherein at least one alcohol is selected as first thickener precursor provided in step a), preferably selected from the group consisting of alcohols with hydrocarbyl or hydrocarbylene groups with 6 to carbon atoms, or mixtures of the aforementioned,
and,
wherein the second thickener precursor provided in step (b) is selected from the group consisting of isocyanates, preferably mono- and/or polyisocyanates with 5 to 20, particularly preferably 6 to 15 carbon atoms, or mixtures of the aforementioned,
wherein the first and/or the second thickener precursor is present as pure substance or as a mixture with at least one base oil.

13. A method for production of a polyurea-thickened grease, consisting of or comprising the steps according to one of claim 11, and additionally the steps:
f) Heating the intermediate product obtained in step e) to a temperature above 100° C. with stirring;
g) Cooling the heated intermediate product from step f) to a temperature below 100° C., preferably below 80° C.;
h) Obtaining a polyurea-thickened grease.

14. Use of an apparatus comprising
a mixing chamber (16) for mixing the thickener precursors,
an agitation reactor (11),
wherein the mixing chamber (16) has a shearing element (17) and at least two dosing inlets (18) for dosing the thickener precursors, and is connected to the agitation reactor via a line (13), in particular wherein the agitation reactor (11) is equipped with a stirrer (12) and a cooling jacket (14), and optionally is connected to the mixing zone (16) via a connection (15) for production of a polyurea-thickened grease (10) or a polyurea-thickened grease intermediate product with a method according to any one of the preceding claims.

15. A polyurea-thickened grease, preferably obtained or obtainable with a method according to claim 1, containing
a) 55 to 95% by weight, preferably 70 to 90% by weight base oil;
b) 1 to 20% by weight, preferably 1.5 to 15% by weight polyurea thickener;
and optionally at least one further component
c) 0.5% by weight to 40% by weight, preferably 2 to 10% by weight additives;
d) 0 to 20% by weight, preferably 0 to 5% by weight, inorganic thickeners, preferably silicon oxide;
f) 0 to 20% by weight, preferably 0.1 to 15% by weight, solid lubricants;
g) 0 to 20% by weight, in particular 1 to 15% by weight, further organic thickeners, preferably soap- or complex soap thickeners based on calcium-, lithium- or aluminium soaps,
h) 1 to 15% by weight lignin derivatives,
wherein the polyurea-thickened grease is substantially free from biuret.

16. The polyurea-thickened grease according to claim 15, wherein the polyurea-thickened grease has a cone penetration value from 200 to 400 mm/10, preferably in the range from 265 to 385 mm/10, determined in accordance with DIN ISO 2137.
